(19) United States
(12) Patent Application Publication
(10) Pub. No.: US 2022/0396316 A1
(43) Pub. Date: Dec. 15, 2022

(54) EXPANSION ELEMENT

(71) Applicant: SIKA TECHNOLOGY AG, Baar (CH)

(72) Inventors: Fabio GABERELL, Murten (CH); Noah MUNZINGER, Zürich (CH)

(73) Assignee: SIKA TECHNOLOGY AG, Baar (CH)

(21) Appl. No.: 17/624,431

(22) PCT Filed: Jul. 16, 2020
(86) PCT No.: PCT/EP2020/070200

§ 371 Date: Jan. 3, 2022

(30) Foreign Application Priority Data
Jul. 26, 2019 (EP) 19188691.0

(51) Int. Cl. B62D 29/00

(52) U.S. Cl. CPC B62D 29/002; B62D 29/005

(57) ABSTRACT

A sheet-like textile is used for a controlled expansion of an expansion element on a structural element in a vehicle body. The sheet-like textile is covered with an expandable material on both sides. The expansion of the expansion element in a direction perpendicular to the sheet-like textile is at least 15% greater than what it would be for an expansion element without a sheet-like textile.

The present invention relates to expansion elements on structural elements in vehicle bodies, more particularly in bodies of motor vehicles, and also to methods for joining two structural elements of a vehicle body with an expansion element of this kind.

Bodies of motor vehicles are often times designed with lightweight constructions. In these instances it is often desirable to provide these lightweight constructions with targeted reinforcement at certain locations. Here, for example, regions of the vehicle body in which cavities have formed can be reinforced by means of inserted reinforcing elements. Alternatively, reinforcing elements may also be bonded to surface regions of the body in order to provide them with reinforcement.

One known approach to the reinforcement of lightweight constructions in motor vehicles is to dispose what are called tapes or pads on a bodywork element, and then to foam and cure them in the paint oven. Such tapes or pads may be used, for example, to join together two substantially opposite structural elements of a vehicle body.

A first such known product is described in US2003/0183317A1. In this case one or more reinforcing layers are disposed in the expandable material, and ultimately provide mechanical reinforcement to the reinforcing element. The reinforcing layer may be formed of different kinds of materials.

Another product similarly known is described in WO2015/011687A1. Here again, a fibrous layer or a nonwoven web is integrated in the expandable material, in order to provide the overall reinforcing element with mechanical reinforcement.

Similar reinforcing elements are also known, additionally, in the form of laminates. One such laminate is disclosed, for example, by WO2011/109699A1. In that case a layer of expandable material is disposed on a foil in each case. In order to achieve attachment between the layers, the surface tensions of the foil and of the expandable material are tailored to one another. The foil is utilized, furthermore, in order to control the expansion of the expandable material disposed thereon.

A disadvantage of the reinforcing element known to date is that, on the one hand, an expansion in a direction perpendicular to a plane of the layers is often inadequate or lacks sufficient control. As a result it becomes necessary to use larger and therefore heavier reinforcing elements in order to be able to close a certain gap between two structural elements of a vehicle body through the expansion of the reinforcing element. With the known solutions, moreover, a disadvantage is that in spite of appropriate measures, a joining between the layers of the reinforcing element is inadequate.

It is therefore an object of the present invention to provide a reinforcing element or expansion element of the aforesaid type that on the one hand has improved expansion in a direction perpendicular to a direction of the layers of the expansion element, and on the other hand enables improved joining between the individual layers of the expansion element. Furthermore, the expansion element ought to be cost-effective and simple both to produce and to use.

This object is achieved firstly by a use of a sheetlike textile for the controlled expansion of an expansion element on a structural element in a vehicle body, the sheetlike textile being covered on both sides with expandable material, and wherein the expansion of the expansion element in a direction perpendicular to the sheetlike textile is greater by at least 15% than would be the case for an expansion element without sheetlike textile.

The object stated above is further achieved by a method for joining two structural elements of a vehicle body with an expansion element, the method comprising the steps of:
providing an expandable material;
providing a sheetlike textile;
forming an expansion element comprising the expandable material and the sheetlike textile, the sheetlike textile being covered on both sides with expandable material; and
expanding the expansion element, wherein an expansion of the expansion element in a direction perpendicular to the sheetlike textile is at least 15% greater than would be the case for an expansion element without sheetlike textile.

The solution proposed herein offers the advantage first of all that as a result of using a sheetlike textile between layers of expandable material, it is possible to achieve improved binding between the layers. It appears to be important here that on curing of the expandable material, the expandable material crosslinks through the sheetlike textile as well. This results in principle in a single, cured, crosslinked expanded element with no functional division.

Surprisingly it has been found that the use of a sheetlike textile in an expandable material of this kind means that expansion in a direction perpendicular to the plane of the sheetlike textile is more pronounced than is the case when a foil is used. It is possible that the typically lower weight of sheetlike textiles relative to foils plays a part here, as does the abovementioned crosslinking through the sheetlike textile.

As a consequence it is possible to provide a method and a use, respectively, with which expansion in the desired direction, more particularly in order to close a gap between two substantially opposite elements, can be substantially improved. The solution described here therefore affords the advantage that smaller and/or lighter expansion elements can be employed than was the case with known expansion elements.

As a result of the more controlled expansion in a defined direction, moreover, the advantage is gained that unwanted foam-filling of adjacent regions can be prevented. For example, it is often undesirable for regions adjacent to the region of intended reinforcement are foam-filled, since otherwise assembly elements, such as holes in a panel, for example, can no longer be utilized.

The text below now describes preferred illustrative embodiments and developments.

In one illustrative development, expansion of the expansion element in a direction perpendicular to the sheetlike textile is greater by at least 20% or by at least 25% or by at least 30% than would be the case for an expansion element without sheetlike textile.

In one illustrative embodiment the sheetlike textile is a mesh.

In an alternative illustrative embodiment, the sheetlike textile is a drawn-loop knit, a woven fabric, a laid scrim, a braded fabric or a formed-loop knit.

In one illustrative embodiment the sheetlike textile has a basis weight of between 5 and 500 g/m², preferably between 5 and 300 g/m², preferably between 5 and 100 g/m², more preferably between 5 and 50 g/m².

In one illustrative embodiment the sheetlike textile has a thickness of between 10 and 1000 μm, preferably between 50 and 500 μm.

The use of sheetlike textiles having such thicknesses and/or such basis weights has the advantage that it is possible as a result to use particularly light, sheetlike textiles. This on the one hand means that an expansion in a direction perpendicular to the sheetlike textile is not hindered by the weight of the sheetlike textile, and on the other hand means that the entire expansion element can be designed with maximum lightness.

In one illustrative embodiment the sheetlike textile has a mesh size of between 0.5 and 15 mm, preferably between 1 and 10 mm, more preferably between 2 and 7 mm.

The provision of such mesh sizes affords the advantage that as a result, on curing of the expandable material, crosslinking through the sheetlike textile is improved.

In one illustrative embodiment fibers of the sheetlike textile have multidirectional orientation.

The use of fibers with multidirectional orientation affords the advantage that as a result, expansion in the vicinity of the sheetlike textile is effectively limited in all directions parallel to a plane of the sheetlike textile. The expandable material consequently undergoes increased expansion in a direction perpendicular to the plane of the sheetlike textile.

In one illustrative embodiment the sheetlike textile has substantially no influence on a tensile strength of the expansion element in the cured state.

This has the advantage in turn that if the mechanical properties are determined only by the expandable material, it is possible to use a particularly lightweight and coarse-meshed sheetlike textile. This leads to the advantages already described above.

In one illustrative embodiment the curing of the expandable material is accompanied by crosslinking of the expandable material through the sheetlike textile.

Such crosslinking through the sheetlike textile affords the advantage that it is possible as a result to ensure improved joining between the individual elements and/or layers of the expansion element.

In one illustrative embodiment the sheetlike textile comprises one or more of the following materials: glass fibers, carbon fibers or polymeric fibers (more particularly polyester fibers).

The use of polymeric fibers in particular affords the advantage that it is possible as a result to provide particularly cost-effective and lightweight sheetlike textiles.

In one illustrative embodiment a surface coverage of the sheetlike textile is less than 80%, preferably less than 50%, more preferably less than 30%.

“Surface coverage” in the context of this invention refers to a percentage coverage of the fibers on a surface in a plan view onto the sheetlike textile (viewing direction perpendicular to the plane of the sheetlike textile).

A surface coverage of 100% therefore means that the fibers of the textile fully cover a surface of the textile, so that there are no spaces at all between the fibers in a plan view. A surface coverage of 50% means, accordingly, that in a plan view half of the surface is covered by fibers, and the other half of the surface consists of spaces between the fibers.

In one illustrative embodiment a plurality of sheetlike textiles are used and/or provided.

In one illustrative development between two and five, or between two and four, or two to three, or precisely two, or precisely three sheetlike textiles are used or are provided to form the expansion element.

It was discovered in experiments that the effect of the increased expansion in a direction perpendicular to the sheetlike textile could be boosted by the provision of a plurality of sheetlike textiles. Accordingly, a suitable number and arrangement of the sheetlike textiles may be selected, depending in particular on a total thickness and an expansion rate of the expandable material.

In one illustrative embodiment the one or more sheetlike textiles are disposed symmetrically in the expansion element.

In one illustrative embodiment the one or more sheetlike textiles are disposed in the expansion element in such a way that a layer thickness of expandable material amounts to at least 10% of a total thickness of the expansion element for each layer formed by the sheetlike textiles.

In one advantageous development the smallest layer thickness of expandable material is at least 15% or at least 20% or at least 25% or at least 30% in relation to the total thickness of the expansion element.

In an alternative embodiment the one or more sheetlike textiles are disposed asymmetrically in the expansion element.

In one illustrative embodiment the method stated at the outset comprises the following additional step: adhering the expansion element on one of the structural elements.

In a first, illustrative development, the expandable material in this case is tacky at room temperature, and the expansion element is detached from a carrier element before it is disposed on the structural element, and the expansion element has a handling foil on one side.

In a second, alternative development, the expandable material is not tacky at room temperature, and the expansion element has an adhesive film on one side for adherence on the structural element.

Both of these illustrative developments have the advantage that the expansion element proposed here may be used as a result in the manner of a tape or in the manner of a pad.

In one exemplary embodiment the expandable material is extruded when the expansion element is formed. In one illustrative development two or more layers of the expandable material are coextruded.

The use of an extruder procedure for forming the expansion element has the advantage that it removes the need for any further steps, such as heating and re-pressing of the various layers, since the liquid material joins up to form one unit in the course of the extrusion.

In one illustrative embodiment the expandable material is an epoxy resin-based or a rubber-based compound.

In one illustrative embodiment the expandable material is a thermosetting material. In one illustrative development the expandable material is configured such that it cures at a temperature between 130° C. and 200° C.

In a first illustrative variant embodiment the expandable material has an expansion rate of between 50% and 800%, preferably between 100% and 500%, preferably between 100% and 300%.

In a second, alternative embodiment the expandable material has an expansion rate of between 1000 and 3000%, preferably between 1000 and 2500%, preferably between 1000 and 2000%.

Illustrative expandable materials which may be used for the expansion elements proposed herein are available under the tradenames SikaReinforcer® and SikaBaffle®.

Details and advantages of the invention are described below using exemplary embodiments and with reference to schematic drawings.

In the drawings:

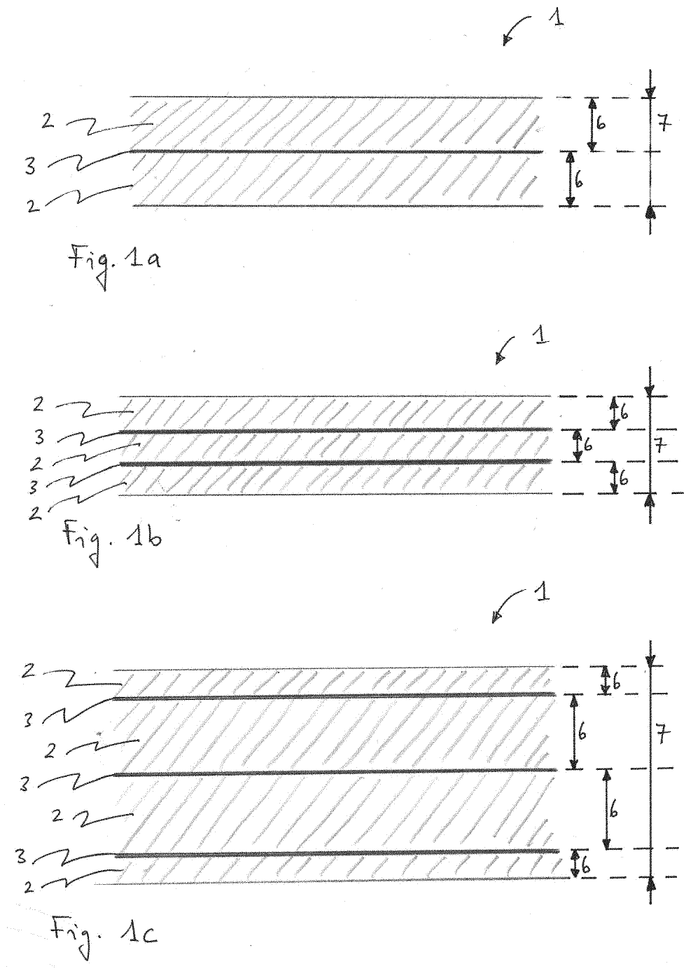

FIGS. 1a to 1c show schematic representation of an expansion element;

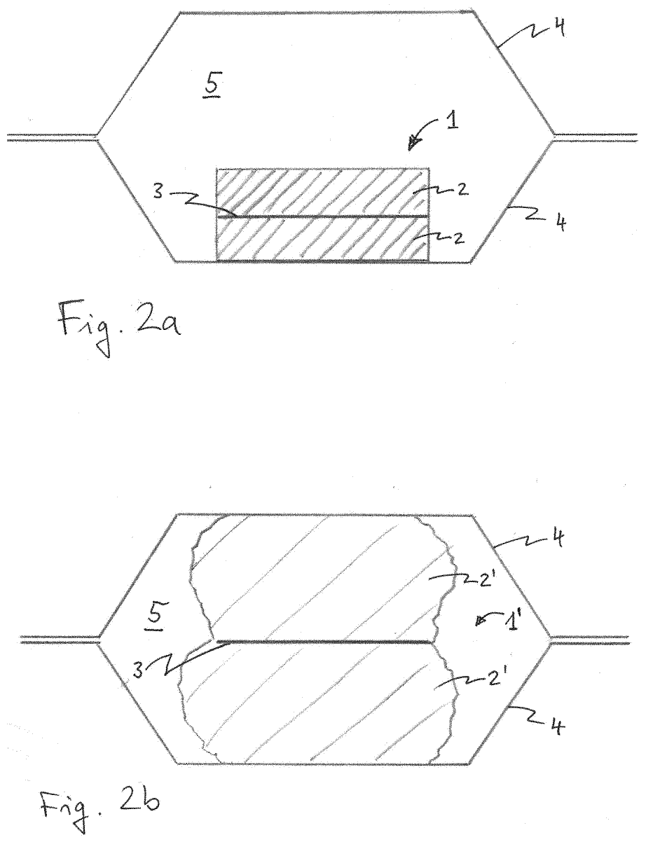

FIGS. 2a and 2b show schematic representation of an expansion element in a cavity of a structural element; and

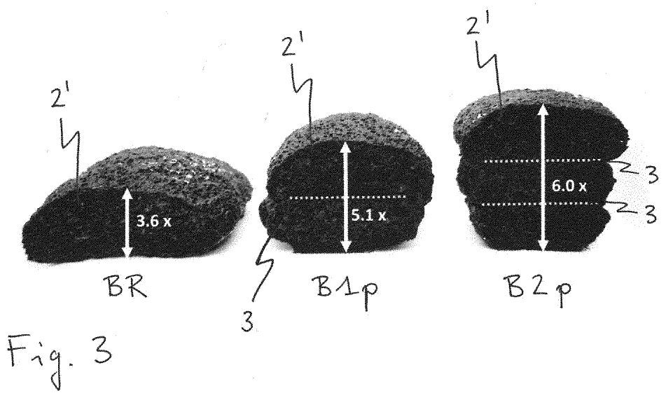

FIG. 3 shows illustrative cross sections of expanded expansion elements from the series of experiments of table 1.

FIGS. 1a to 1c represent various exemplary embodiments of expansion elements 1.

In this case the expansion elements 1 are each shown in a cross-sectional representation. Each expansion element 1 comprises expandable material 2 and one or more sheetlike textiles 3. A total thickness 7 of the expansion element 1 is divided here by the sheetlike textiles 3 into individual layers, with each of the layers having a layer thickness 6. In all three exemplary embodiments, a smallest layer thickness 6 of the expansion element 1 is designed in each case such that it amounts to at least 10% of the total thickness 7 of the expansion element 1.

In the three exemplary embodiments represented, the sheetlike textiles 3 are disposed in each case symmetrically in the expansion element 1. In an alternative exemplary embodiment not represented, however, the sheetlike textiles 3 may also be disposed nonsymmetrically.

In FIGS. 2a and 2b an expansion element 1 is disposed in a cavity 5 of a structural element 4. FIG. 2a here shows the expansion element 1 in an unexpanded state, and FIG. 2b shows the same expansion element 1′ in an expanded state.

In this representation it can be seen that through the provision of a sheetlike textile 3 between layers of expanded material 2, increased expansion in a direction perpendicular to the sheetlike textile 3 is achieved, thereby making it possible to close an existing gap between two substantially opposite structural elements using a relatively small expansion element 1.

In FIG. 2b it is apparent that the expanded material 2′, especially in the vicinity of the sheetlike textile 3 and in the vicinity of the structural elements 4, expands to less of an extent in directions along the plane of the sheetlike textile 3 than would be the case without an attachment to the sheetlike textile 3 and to the structural element 4, respectively. As a result of this effect, there is increased expansion perpendicularly to the plane of the sheetlike textile 3.

Table 1 below represents an illustrative experimental series of illustrative expansion elements. In these experiments, different expandable materials and also different sheetlike textiles (and also a comparative experiment with an aluminum foil rather than a sheetlike textile) are employed.

Expandable materials used were SikaReinforcer®-604 (denoted SR-604) and also SikaBaffle®-235 (denoted SB-235).

Sheetlike textiles employed were polyester mesh, woven glass fiber fabric, and woven carbon fiber fabric. In these contexts, experiments with a sheetlike textile, experiments with two sheetlike textiles, and reference experiments without sheetlike textiles were carried out.

Additionally, an experiment with an aluminum foil rather than a sheetlike textile was carried out (sample R1a).

TABLE 1

| | | | Increase in height | |
|---|---|---|---|---|
| | | | | Relative |
| | Expand. | Number and nature | | to the |
| Sample | Material | of sheetlike textile | Factor | reference |
| RR | SR-604 | Reference (no textile) | 2.01 ± 0.01 | |
| R1p | SR-604 | . . . with 1 polyester mesh | 2.51 ± 0.03 | 25% |
| R1g | SR-604 | . . . with 1 glass fiber fabric | 2.43 ± 0.03 | 21% |
| R1c | SR-604 | . . . with 1 carbon fiber fabric | 2.50 ± 0.03 | 24% |
| R1a | SR-604 | . . . comparative experiment | 2.26 ± 0.01 | 12% |
| | | with 1 aluminum foil | | |
| RR | SR-604 | Reference (no textile) | 2.13 ± 0.01 | |
| R2p | SR-604 | . . . with 2 polyester meshes | 2.92 ± 0.07 | 37% |
| R2g | SR-604 | . . . with 2 glass fiber fabrics | 2.59 ± 0.07 | 22% |
| R2c | SR-604 | . . . with 2 carbon fiber fabrics | 2.54 ± 0.05 | 19% |
| BR | SB-235 | Reference (no textile) | 3.61 ± 0.11 | |
| B1p | SB-235 | . . . with 1 polyester mesh | 5.14 ± 0.02 | 42% |
| B2p | SB-235 | . . . with 2 polyester meshes | 6.00 ± 0.13 | 66% |

First of all it is apparent from the experimental series that the sheetlike textiles have a significant influence on the increase in height when the expansion element is expanded.

Furthermore, it was found that sheetlike textiles produce a greater increase in height than is the case with foils. The comparative experiment with aluminum foil produced a height increase of 12% relative to the reference without sheetlike textile, whereas all of the experiments with sheetlike textiles produced an increase in height of at least 15%.

The result of the comparative experiment with aluminum foil is additionally confirmed by the aforementioned WO2011/109699A1, in which table 2, with reinforcing foils in the four examples A to D, found the following values for the percentage increase in height in comparison to the reference example: example A−3%, example B+8%, example C+12%, and example D+14%.

From this experimental series it is apparent, moreover, that the greater the number of sheetlike textiles used, the greater the expansion perpendicular to the plane of the sheetlike textile, referred to as increase in height in the table. For instance, when using two sheetlike textiles, the expansion in this direction is greater than when using one sheetlike textile, and when using a sheetlike textile the expansion in the desired direction is greater than for the reference example without sheetlike textile.

FIG. 3 depicts three illustrative cross sections from the experimental setup represented in table 1. This FIG. 3 shows the three lowermost experiments of the experimental setup according to table 1 (samples BR, B1p and B2p). In this representation of cross sections of the resulting samples as well, the effect of the sheetlike textiles 3, in improving an expansion in a direction perpendicular to the sheetlike textiles 3, is apparent.

In FIG. 3, the position of the sheetlike textiles 3 (polyester meshes in this exemplary embodiment) has been indicated with dashed lines, since the textiles would be otherwise invisible because of the proportions and the contrasts.

### LIST OF REFERENCE NUMERALS

1—expansion element in unexpanded state
1′— expansion element in expanded state
2—expandable material
2′—expanded material
3—sheetlike textile
4—structural element
5—cavity
6—layer thickness
7—total thickness

1. A method comprising:
applying a sheetlike textile for the controlled expansion of an expansion element on a structural element in a vehicle body, the sheetlike textile being covered on both sides with expandable material, and
expanding the expansion element; wherein the expansion of the expansion element in a direction perpendicular to the sheetlike textile is greater by at least 15% than would be the case for an expansion element without sheetlike textile.

2. The method as claimed in claim 1, wherein the sheetlike textile is a mesh.

3. The method as claimed in claim 1, wherein the sheetlike textile has a basis weight of between 5 and 500 g/m².

4. The method as claimed in claim 1, wherein the sheetlike textile has a thickness of between 10 and 1000 μm.

5. The method as claimed in claim 1, wherein the sheetlike textile has a mesh size of between 1 and 10 mm.

6. The method as claimed in claim 1, wherein fibers of the sheetlike textile have multidirectional orientation.

7. The method as claimed in claim 1, wherein the sheetlike textile substantially does not influence a tensile strength of the expansion element in a cured state.

8. The method as claimed in claim 1, further comprising: curing the expandable material and crosslinking the expanded material through the sheetlike textile.

9. The method as claimed in claim 1, wherein the sheetlike textile comprises at least one or more of the following materials: glass fiber, carbon fibers, or polymeric fibers.

10. The method as claimed in claim 1, wherein two to five sheetlike textiles are applied.

11. A method for joining two structural elements of a vehicle body with an expansion element, the method comprising:
providing an expandable material;
providing a sheetlike textile;
forming an expansion element comprising the expandable material and the sheetlike textile, the sheetlike textile being covered on both sides with expandable material; and
expanding the expansion element, wherein an expansion of the expansion element in a direction perpendicular to the sheetlike textile is at least 15% greater than would be the case for an expansion element without sheetlike textile.

12. The method as claimed in claim 11, wherein the method further comprises:
adhering the expansion element on one of the structural elements.

13. The method as claimed in claim 12,
wherein the expandable element is tacky at room temperature,
wherein the expansion element is detached from a carrier element before it is disposed on the structural element, and
wherein the expansion element has a handling foil on one side.

14. The method as claimed in claim 12, wherein the expandable material is not tacky at room temperature, and wherein the expansion element has an adhesive film on one side for adherence on the structural element.

15. The method as claimed in claim 11, wherein the method comprises extruding the expandable material when the expansion element is formed.
